(19) United States
(12) Patent Application Publication
(10) Pub. No.: US 2021/0398126 A1
(43) Pub. Date: Dec. 23, 2021

(54) BLOCKCHAIN INFORMATION DETERMINATION SERVER, BLOCKCHAIN INFORMATION DETERMINATION METHOD, AND RECORDING MEDIUM IN WHICH BLOCKCHAIN INFORMATION DETERMINATION PROGRAM IS RECORDED

(71) Applicant: BIGSTER INC., Seoul (KR)

(72) Inventor: Hyun Jong LEE, Seoul (KR)

(73) Assignee: BIGSTER INC., Seoul (KR)

(21) Appl. No.: 17/287,893

(22) PCT Filed: Oct. 24, 2018
(86) PCT No.: PCT/KR2018/012643

§ 371 Date: Apr. 22, 2021

(51) Int. Cl. G06Q 20/40; G06Q 30/02

(52) U.S. Cl. CPC G06Q 20/4016; G06Q 2220/00; G06Q 30/0217

(57) ABSTRACT

The present invention discloses a blockchain information determination server and a recording medium in which a program is recorded. In other words, the present invention is intended to overcome the above-described problems, and provides a technology that performs the confirmative determination of report information regarding fake news by calculating the degrees of reliability of actors who participate in a blockchain. According to the present invention, the following effects are achieved: First, the report information used to determine whether news is fake news may be shared by multiple subjects. Second, the present invention contributes to the activation of a system by providing rewards to a subject who determines whether news is fake news and a system management subject via reliability. Third, the present invention contributes to the automation of the blocking of fake news by performing the probabilistic determination of whether news is fake news based on reliability.

### TECHNICAL FIELD

The present invention relates to a blockchain information determination server, a blockchain information determination method, and a recording medium in which a blockchain information determination program is recorded in the field of blockchain information determination technology.

### BACKGROUND ART

As fraudulent activities using various types of false information such as various types of financial fraud, fraudulent trading based on false products for sales, the presentation of a false career or false working conditions, fake news, and false genomes, become serious problems, there is a need to provide report information regarding various types of fraudulent activities to the general public and individual institutions in a reliable manner. In particular, fake news is causing political and social problems in many countries.

However, such online report information has been collected and held by individual reliable relevant institutions so far, so that there is an information asymmetry situation in which there is not provided an environment in which the general public and relevant institutions can refer to each other's information. Furthermore, there are problems regarding the duplication of fraud-suspicious information and the cost and time required for the determination of authenticity.

Therefore, there is a need for a reliable determination system that overcomes information asymmetry by sharing such various types of false or suspicious information and is reliable in evaluating the shared various types of false or suspicious information.

As a conventional technology presented to overcome the above problems, Korean Patent No. 10-1206863 (registered on Nov. 26, 2012) is directed to a method and apparatus that receive feedback information on online network posts written by online network users and calculate the reputations of the online network users by taking into consideration sociality based on the feedback between the online network users. There are disclosed an online network user reputation calculation method that is implemented in an online network user reputation calculation apparatus. The online network user reputation calculation apparatus is characterized by performing the steps of: receiving, by a reception unit, feedback information on online network posts written by a plurality of online network users, acquiring, by a first information acquisition unit, first information that is a probability that each of the users will provide feedback to a first one of the users, and calculating, by a reputation score calculation unit, the reputation score of the first user by using the first information.

The technology of the above-described patent publication only calculates reputation based on social relations between users, but does not take into consideration whether various types of information produced by the users are false, so that the technology is problematic in terms of the utilization of reputation.

### DISCLOSURE

### Technical Problem

The present invention is intended to overcome the above-described problems, and provides a technology that performs the confirmative determination of report information regarding fake news by calculating the degrees of reliability of actors who participate in a blockchain.

### Technical Solution

In order to accomplish the above-described object, according to a first aspect of the present invention, there is provided a blockchain information determination server including: a blockchain connection unit configured to connect with a blockchain that is configured to connect nodes including block producers; a management unit configured to perform information management tasks for transaction information between nodes brought through the connection unit; a reliability calculation unit configured to calculate the degrees of reliability of clients that have uploaded unconfirmed report information to the blockchain based on the transaction information brought through the management unit; a storage unit configured to store the reliability information calculated by the reliability calculation unit and previously acquired report information; and a report information determination unit configured to determine whether newly uploaded unconfirmed report information is confirmed report information based on the information stored in the storage unit, and to provide results of the determination to the blockchain through the connection unit.

In order to accomplish the above-described object, according to a second aspect of the present invention, there is provided a recording medium having recorded thereon a blockchain information determination program that is executable, on a computer apparatus: a blockchain connection function of connecting with a blockchain that is configured to connect nodes including block producers; a management function of performing information management tasks for transaction information between nodes brought by the connection function; a reliability calculation function of calculating the degrees of reliability of clients that have uploaded unconfirmed report information to the blockchain based on the transaction information brought by the management function; a storage function of storing the reliability information calculated by the reliability calculation function and previously acquired report information; and a report information determination function of determining whether newly uploaded unconfirmed report information is confirmed report information based on the information stored by the storage function and providing results of the determination to the blockchain through the connection function.

In order to accomplish the above-described object, according to a third aspect of the present invention, there is provided a blockchain information determination method including: a collection step of collecting and hashing report information regarding various types of articles reported by clients and client information; a storage step of storing the report information and client information, collected and hashed in the collection step, in a storage unit as hash values; a conversion step of producing determination variables including a probability that report information uploaded by an actor to a blockchain is found to be actual report information and the utilization of negatively-confirmed report information of the actor through the information stored in the storage step; a reliability calculation step of calculating the reliability score of a client through the determination variables produced in the conversion step; a determination step of determining that the unconfirmed report information is negatively-confirmed report information by determining whether the unconfirmed report information is negative through an evaluation variable including at least one of the reliability score calculated in the reliability calculation step, the frequency of provision of unconfirmed report information within a short period of time, and the frequency of redundant provision of unconfirmed report information; and an update step of updating the reliability score, calculated by the reliability calculation step, to a new reliability score depending on whether the report information is negative that is determined through the determination step.

### Advantageous Effects

According to the present invention, the following effects are achieved: First, the report information used to determine whether news is fake news may be shared by multiple subjects.

Second, the present invention contributes to the activation of a system by providing rewards to a subject who determines whether news is fake news and a system management subject via reliability.

Third, the present invention contributes to the automation of the blocking of fake news by performing the probabilistic determination of whether news is fake news based on reliability.

### DESCRIPTION OF DRAWINGS

FIG. 1 is a schematic diagram showing a blockchain composed of a plurality of blocks generated by transactions of report information used by nodes in the present invention and the service performed in a blockchain information determination server;

FIG. 2 is a block diagram illustrating a blockchain information determination server according to a first embodiment of the present invention;

FIG. 3 is a block diagram illustrating a reliability calculation unit according to the first embodiment of the present invention; and

FIG. 4 is a block diagram illustrating a report information determination unit according to the first embodiment of the present invention.

### MODE FOR INVENTION

Embodiments of the present invention will be described in detail below with reference to the accompanying drawings. In the following description, when it is determined that a detailed description of related known technologies may unnecessarily obscure the gist of the present invention, the detailed description thereof will be omitted. Furthermore, numbers used in a process in which the present specification is described are merely identification symbols each intended to distinguish one component from other components.

Preferred embodiments of the present invention will be described in greater detail, but technical parts that are already well known will be omitted or abridged for brevity of description.

<Description of Blockchain>

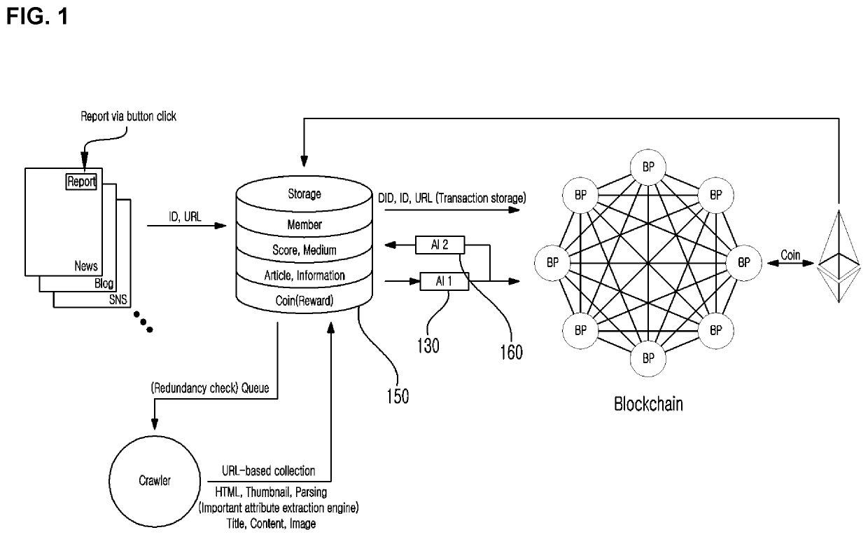

A blockchain information determination server 100 according to a first embodiment of the present invention is configured as illustrated in FIG. 1.

A blockchain refers to a peer-to-peer (P2P) distributed network composed of a plurality of nodes storing a kind of distributed ledger. In such a blockchain, at least some nodes may perform the same processing, so that the blockchain is characterized in that even when the information of some nodes is forged, the overall blockchain is not affected. Nodes may mean all computing devices connected to the blockchain. These nodes may include a digital wallet, a blockchain copy, a verification engine, a mining engine, and a P2P network distribution function (a broadcast function), and may also include clients having simpler functions.

In an embodiment of the present invention, the nodes include block producers (BP members) as actors. The reason for this is to increase speed compared to the speed in the case where a blockchain is implemented in POW (Proof of work) used in an existing blockchain in such a manner that clients delegate authority to block producers (BP members), which are restricted nodes, and thus allow them to perform roles in the transmission and/or verification of transactions, the production of blocks, etc. Such a client may perform the act of providing information to a blockchain information determination server for negatively-confirmed determination by reporting fake news. Such a block producer (such a BP member) may refer to a node including a network routing module and a database for the generation and storage of transactions. Such a client may refer to a lightweight node including only a network routing module. In other words, the node may play the roles of storing transaction details, acknowledging transactions and performing a distributed agreement, and the client may check the results of transactions. The node has a transaction storage database. An application database that is applied to an application using this is held in the separate storage of a blockchain information determination server. In this case, the blockchain may be applied to a transaction storage database.

In the database of the server of the node on the blockchain, a hash value for news data and a hash value for the client may be associated with an authentication module, such as a public key and a private key, and the private key may be connected to the member information stored in the storage unit 150 of the blockchain information determination server, so that client management is enabled.

In the above-described storage unit 150, data on BP information, client information, media information, article information (a reported news page address (URL), a thumbnail, a media ID, etc.), article and client reliability scores, and coin transaction information (payment details, usage details, etc.) may be stored.

In other words, the above-described application database may store a reported news page address (URL), thumbnail data, a client reliability score, etc., and the hash value, timestamp, etc. of data, such as a news URL, a thumbnail and member information described above, stored in the application database may be stored in the blockchain.

More specifically, the hash values, timestamps, etc. of data stored in the storage unit 150 of the blockchain information determination server may be encrypted and stored in the database of the node server on the blockchain.

For example, for the member subscription information of the client, the storage unit 150 may store an identifiable ID or the like as the original thereof so that it can be searched for, and the blockchain may store it as a hash value.

The present invention may be applied to both a public blockchain and a private blockchain, or may be applied to a method in which the two types of blockchains interact with each other. For example, a consortium blockchain, which is one of such private blockchains, is a semi-centralized blockchain that does not require mining and is controlled by a preselected node, unlike a public blockchain that can be viewed/transmitted by anyone. This has the characteristics of a private blockchain, each node is operated by a limited institution, and a transaction is made only when there is an agreement between the nodes of respective institutions. However, there are various forms such as a form in which the right to view is given to the public. When an implementation is made in such a consortium blockchain, the client may view the negatively-confirmed information of report information or makes a report for negatively-confirmed determination with respect to the blockchain information determination server connected to the semi-centralized blockchain constructed through the nodes operated by block producers (BP members) corresponding to institutions among actors. Nodes such as BPs on the consortium blockchain perform management, such as the generation, storage, and verification of a large number of transactions for the purpose of the integrity and security of the above-described transactions.

According to an embodiment of the present invention, nodes that are specifically block producers (BP members) participate in the blockchain in order to use negatively-confirmed report information guaranteed by the blockchain. Blocks are generated by verifying collected transactions according to the cycle of block generation policies so that transactions that occur each time nodes use information are recorded, thereby forming a blockchain. Nodes that are block producers (BP members) may receive more reliability scores as rewards as they participate in the blockchain more actively and perform more activities. Accordingly, participating institutions may unify a database by actively sharing negative report information, so that it is expected that unnecessary time and cost used to verify report information will be reduced and participating institutions will actively perform activities on the blockchain in order to increase their reliability.

A client who has made a report may receive a reward as one or more coins or the like through a separate reward blockchain when the client reports fake news or finds fake news because report information is found to be negatively-confirmed information. Such rewards may motivate clients to make reports.

In other words, such a blockchain system may prevent the forgery and tempering of transactions while integrating fraud reporting information scattered in the past, may provide reliability as a reward in the case of active participation in order to motivate institutions, which are participants, to actively perform such use, and may determine whether it is conformed that unconfirmed report information is negatively-confirmed information based on the above-described reliability, thereby providing the effect of providing a technology for determining whether fraud reporting information is confirmed information in a more reliable manner.

<Description of Blockchain Information Determination Server>

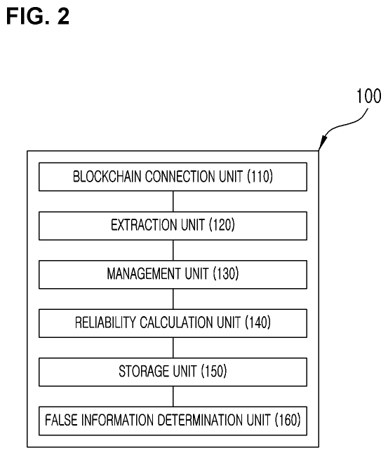

As illustrated in FIG. 2, a blockchain information determination server according to an embodiment of the present invention includes a blockchain connection unit 110, a management unit 130, a reliability calculation unit 140, a storage unit 150, and a report information determination unit 160.

The connection unit 110 performs the function of allowing connection to a blockchain configured to connect nodes composed of block producers (BP members). This may refer to a network routing module that broadcasts transactions to the blockchain. Actors may connect with the blockchain information determination server through the connection unit 110, and a transaction occurs each time information is used. The generation and storage of such transactions are performed on the blockchain by nodes.

The management unit 130 performs information management tasks including addition, transfer, update, and deletion for transaction information brought through the connection unit, and may also perform the task of producing determination variables necessary for the calculation of reliability and the determination of report information to be described later from information stored in the storage unit 150. The management unit 130 may store the transaction information as hash values.

The determination variables may include at least one of the degree of occurrence of a transaction of the client, a probability that the report information posted by the client on the blockchain is found to be actual report information, and the utilization of negatively-confirmed report information of the client.

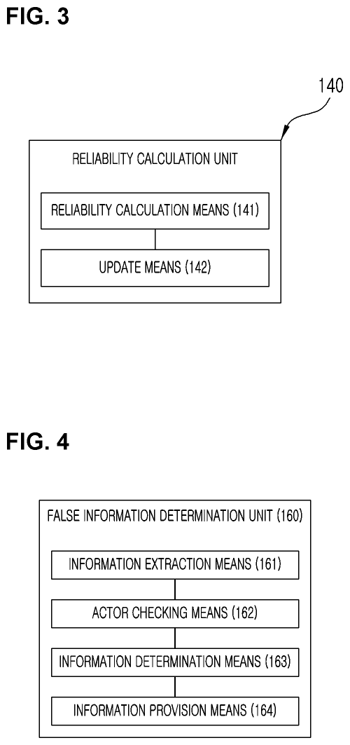

As illustrated in FIG. 3, the reliability calculation unit 140 calculates the degrees of reliability of actors who have uploaded report information based on the information stored in the storage unit 150 or the hash values stored in the nodes of the blockchain. Furthermore, the reliability calculation unit may include a reliability calculation means for calculating the degrees of reliability using various determination variables produced by the above-described management unit 130, and an update means for updating the degrees of reliability, calculated by the reliability calculation means, to new reliability scores.

It should be noted that the above-described various variables may vary depending on the applicable case.

Through this, the degrees of reliability of the respective actors are updated and provided to the respective actors. Through this, the degrees of reliability may be increased by active participation in the blockchain, so that these degrees of reliability may function as rewards for the participation of actors.

The storage unit 150 stores the determination variables produced by the management unit 130, BP information, client information, media information (a country, a basic URL, etc.), article information (the hash values of a URL, a thumbnail, etc. collected by a web crawler), the reliability scores of the article and the client, previously acquired information, and report information.

As illustrated in FIG. 4, the report information determination unit 160 determines whether newly uploaded unconfirmed report information is negatively-confirmed report information based on the determination variables that are produced by the management unit 130 based on the information stored in the storage unit 150 storing the reliability information calculated by the reliability calculation unit and the reliability score of the client who has made a report, and provides the results of the determination to the blockchain through the connection unit.

In this case, the determination variables refer to the member information of general actors, negatively-confirmed or unconfirmed report information that is the transaction information collected by an institution operating each node, the number of reports for each of which the report information uploaded by an actor on the blockchain is found to be an actual false transaction, the utilization of negatively-confirmed or unconfirmed report information of actors, the frequency of provision of unconfirmed report information within a short period of time, and the frequency of redundant provision of unconfirmed report information. The determination variables may be newly stored and updated or discarded through the management unit 130 from time to time.

According to an embodiment of the present invention, the report information determination unit 160 may operate when provided report information satisfies a predetermined reference value. In other words, the report information determination unit 160 may not perform the function thereof when each of the above-described actors makes a report for the first time, but may perform the function thereof when repeated reports are made and thus the frequency exceeds a predetermined reference value, when reports are repeatedly made within a predetermined period of time, or when a report is made by an actor having high reliability.

Furthermore, the report information determination unit 160 includes an information extraction means 161, an actor checking means 162, an information determination means 163, and an information provision means 164.

The information extraction means 161 extracts unconfirmed report information from new information newly stored in the storage unit.

The actor checking means 162 checks an actor who has uploaded the unconfirmed report information extracted by the information extraction means, and checks the degree of reliability of the corresponding actor by referring to the reliability information stored in the storage unit.

The information determination means 163 determines unconfirmed report information to be negatively-confirmed report information by determining whether the unconfirmed report information is negative based on the actor and the reliability information of the corresponding actor identified by the actor checking means 152.

The information provision means 164 provides the results of the determination, obtained by the information determination means 163, to the blockchain through the connection unit, and provides the results of the determination to the storage unit.

Furthermore, the information determination means 163 is characterized by determining that unconfirmed report information is negatively-confirmed report information by determining whether the unconfirmed report information is negative through a determination variable including at least one of the reliability information of the actor, the frequency of provision of unconfirmed report information within a short period of time, and the frequency of redundant provision of unconfirmed report information.

It should be noted that the above-described various variables may vary depending on the applicable case.

Furthermore, the results of the determination provided by the information provision means 164 and obtained by the information determination means are the negatively-confirmed report information probabilistically determined according to the determination variable, are provided to the connection unit to be provided to the blockchain so that they can be used by actors to determine whether the report information is negative, and are provided such that the reliability calculation means and the report information determination unit provide the above-described functions.

<Specific Process of Determining Whether it is Confirmed that Report Information is Negative>

As described above, the technology for determining whether it is confirmed that report information is negative based on the degree of reliability of an actor may be applied to various fields. A process commonly applicable in various fields will be described below.

Individual actors connected to the blockchain record transactions in the blockchain while using predetermined negatively-confirmed report information through the connection unit 110 in the database of the blockchain information determination server. The following describes a process for newly registered unconfirmed report information according to an embodiment of the present invention.

First, during the posting of information or a transaction as in a homepage, a community, media, or the like, posted information or transaction information may be provided to the blockchain information determination server through the connection unit 110 as unconfirmed report information by the reporting or information provision of individual actors.

For example, there may be performed the step of checking whether report information has been redundantly reported by comparing the information with the URL and thumbnail of fake news that have already been collected by a web crawler or the like. In this case, the collected information may be hashed and stored as a hash value. In the case of the determination of redundancy, determination is performed by comparing newly registered unconfirmed report information with the above hash value.

If such unconfirmed report information is repeatedly reported to exceed a predetermined reference, whether it is confirmed that the unconfirmed report information is negative is determined by the report information determination unit 160. First, the information extraction means 161 extracts unconfirmed report information from the new information that is newly stored in the storage unit. The actor checking means 162 checks the reliability information of an actor who has uploaded the unconfirmed report information by referring to the storage unit. Thereafter, the information determination means 163 may probabilistically determine whether it is confirmed that the report information is negative based on the above-described variables based on the previously calculated transaction or the degree of reliability recorded in the blockchain of the actor who has made the report or has provided information. The results of the redetermination are provided to the individual actors through the connection unit, and are provided to and stored in the storage unit.

Accordingly, if it is determined whether the report information is actual report information in the future, the degree of reliability of each actor is periodically calculated through various determination variables by the reliability calculation means 141 of the reliability calculation unit 140 based on the new data, and the degree of reliability is updated by the update means 142. As described above, the updated degree of reliability is again used by the report information determination unit 160 to determine whether it is confirmed that report information is negative. Furthermore, the updated degree of reliability may be provided as a reward to each actor who has made a report or has provided information. A client who has additionally made a report may receive a reward as one or more coins or the like through a separate reward blockchain when fake news is found because report information is determined to be negatively-confirmed information. Such rewards may motivate clients to make reports.

However, it should be considered that the order or variables of the above-described process may be variable.

<Description of Recording Medium in which a Blockchain Information Determination Program is Recorded>

Meanwhile, the above-described present invention may be implemented as a computer-readable code on a computer-readable recording medium. The computer-readable recording medium includes all types of recording devices that store data that can be read by a computer system. Examples of the computer-readable recording medium include ROM, RAM, CD-ROM, magnetic tape, a floppy disk, and an optical data storage device. Furthermore, the computer-readable recording medium is distributed over a computer system connected through a network, so that a computer-readable code may be stored and executed in a distributed manner.

The blockchain information determination program recorded in such a recording medium includes a connection function, an extraction function, a reliability calculation function, a storage function, and a report information determination function.

Through the blockchain connection function, it may be possible to connect to the blockchain configured to connect actors including one or more clients and one or more block producers (one or more BP members).

Through the management function, there may be performed information management tasks including addition, transfer, update, and deletion for the transaction information brought by the connection function.

Through the reliability calculation function, the degrees of reliability of actors who have posted report information on the blockchain may be calculated based on the information extracted by the extraction function.

Through the storage function, the reliability information calculated by the reliability calculation function may be stored.

Furthermore, the blockchain information determination program recorded in such a recording medium may execute the report information determination function of determining whether newly uploaded unconfirmed report information is negatively-confirmed report information based on the reliability stored in the storage function and providing the results of the determination to the blockchain through the connection unit on a computer apparatus.

The remaining technologies of the present invention described above may also be implemented as computer-readable codes on a computer-readable recording medium.

<Description of Blockchain Information Determination Method for Blockchain Information Determination Program>

The specific operation methods of the first and second aspects of the above-described present invention are as follows.

A blockchain information determination method according to a third aspect of the present invention includes a collection step, a storage step, a conversion step, a calculation step, a determination step, and an update step.

In the collection step, report information about various articles reported by clients and client information are collected, and hashed. The hashing is the conversion of a character string into a shorter-length value or key that symbolizes the original thereof, and it may be possible to determine whether information matches each other by comparing hash values.

In the storage step, the report information and client information collected in the collection step are stored in the storage unit of the server, and the hashed report information and client information are stored in the blockchain as hash values.

In the conversion step, determination variables including the probability that the report information uploaded by the actors is determined to be actual report information and the utilization of negatively-conformed report information of the actors are produced through the information stored in the storage step.

In the calculation step, the reliability score of the client is calculated through the determination variables produced in the conversion step.

In the determination step, it is determined that unconfirmed report information is negatively-confirmed report information by determining whether the unconfirmed report information is negative through an evaluation variable including at least one of the reliability score calculated in the reliability calculation step, the frequency of provision of unconfirmed report information within a short period of time, and the frequency of redundant provision of unconfirmed report information. The above-described evaluation variable is not limited thereto.

In the update step, the reliability score calculated by the reliability calculation step is updated to a new reliability score depending on whether the report information is negative that is determined through the determination step.

As described above, while the specific description of the present invention has been given based on the embodiments, the above-described embodiments have been only described with reference to preferred examples of the present invention. It should not be understood that the present invention is limited to the above embodiments, and the scope of the present invention should be understood as including the claims to be described later and equivalent concepts thereof.

### <DESCRIPTION OF REFERENCE SYMBOLS>

100: blockchain information determination server
110: connection unit
130: management unit
140: reliability calculation unit
141: reliability calculation means
142: update means
150: storage unit
160: report information determination unit
161: information extraction means
162: actor checking means
163: information determination means
164: information provision means

### INDUSTRIAL APPLICABILITY

The present invention may be considerably usefully applied to a case where blockchain information is determined. According to the present invention, the degrees of reliability are given as rewards for active participation in order to motivate the institutions that are the subjects of participation in the integration of report information scattered in the past, and whether unconfirmed report information is negative report information is calculated based on the given degrees of reliability, thereby determining negative report information in a more reliable manner.

1. A blockchain information determination server comprising:
a blockchain connection unit configured to connect with a blockchain that is configured to connect nodes including block producers;
a management unit configured to perform information management tasks for transaction information between nodes brought through the connection unit;
a reliability calculation unit configured to calculate degrees of reliability of clients that have uploaded unconfirmed report information to the blockchain based on the transaction information brought through the management unit;
a storage unit configured to store the reliability information calculated by the reliability calculation unit and previously acquired report information; and
a report information determination unit configured to determine whether newly uploaded unconfirmed report information is confirmed report information based on the information stored in the storage unit, and to provide results of the determination to the blockchain through the connection unit.

2. The blockchain information determination server of claim 1, wherein the reliability calculation unit comprises:
a reliability calculation means configured to calculate each of the degrees of reliability of the clients by using a determination variable including at least one of a degree of occurrence of a transaction of a corresponding client, a probability that report information posted by the client on the blockchain is actually found to be negatively-confirmed report information, and a utilization of negatively-confirmed report information of the client; and
an update means configured to update the degrees of reliability, calculated by the reliability calculation means, to new degrees of reliability.

3. The blockchain information determination server of claim 1, wherein the report information determination unit comprises:
an information extraction means configured to extract unconfirmed report information from new information newly stored in the storage unit;
an actor checking means configured to check an actor who has uploaded the unconfirmed report information extracted by the information extraction means, and to check a degree of reliability of the corresponding actor by referring to the reliability information stored in the storage unit;
an information determination means configured to determine that the unconfirmed report information is negatively-confirmed report information by determining whether the unconfirmed report information is negative based on the actor and the reliability information of the corresponding actor identified by the actor checking means; and
an information provision means configured to provide results of the determination, obtained by the information determination means, to the storage unit.

4. The blockchain information determination server of claim 3, wherein the information determination means determines that the unconfirmed report information is negatively-confirmed report information by determining whether the unconfirmed report information is negative through a determination variable including at least one of reliability information of an actor, a frequency of provision of unconfirmed report information within a short period of time, and a frequency of redundant provision of unconfirmed report information.

5. The blockchain information determination server of claim 1, further comprising a reward unit configured to connect with a reward blockchain in order to provide one or more coins as a reward to a client who has made a report.

6. A recording medium having recorded thereon a blockchain information determination program that is executable, on a computer apparatus:
a blockchain connection function of connecting with a blockchain that is configured to connect nodes including block producers;
a management function of performing information management tasks for transaction information between nodes brought by the connection function;
a reliability calculation function of calculating degrees of reliability of clients that have uploaded unconfirmed report information to the blockchain based on the transaction information brought by the management function;
a storage function of storing the reliability information calculated by the reliability calculation function and previously acquired report information; and
a report information determination function of determining whether newly uploaded unconfirmed report information is confirmed report information based on the information stored by the storage function and providing results of the determination to the blockchain through the connection function.

7. The recording medium of claim 6, wherein the report information determination function comprises:
an information extraction means configured to extract unconfirmed report information from new information newly stored in the storage unit;
an actor checking means configured to check an actor who has uploaded the unconfirmed report information extracted by the information extraction means, and to check a degree of reliability of the corresponding actor by referring to the reliability information stored in the storage unit;
an information determination means configured to determine that the unconfirmed report information is negatively-confirmed report information by determining whether the unconfirmed report information is negative based on the actor and the reliability information of the corresponding actor identified by the actor checking means; and
an information provision means configured to provide results of the determination, obtained by the information determination means, to the storage unit.

8. The recording medium of claim 7, wherein the information determination means determines that the unconfirmed report information is negatively-confirmed report information by determining whether the unconfirmed report information is negative through a determination variable including at least one of reliability information of an actor, a frequency of provision of unconfirmed report information within a short period of time, and a frequency of redundant provision of unconfirmed report information.

9. The recording medium of claim 6, wherein the reliability calculation function comprises:
a reliability calculation means configured to calculate each of the degrees of reliability of the clients by using a determination variable including at least one of a degree of occurrence of a transaction of a corresponding client, a probability that report information posted by the client on the blockchain is actually found to be negatively-confirmed report information, and a utilization of negatively-confirmed report information of the client; and
an update means configured to update the degrees of reliability, calculated by the reliability calculation means, to new degrees of reliability.

10. The recording medium of claim 6, further comprising a reward function of connecting with a reward blockchain in order to provide one or more coins as a reward to a client who has made a report.

11. A blockchain information determination method comprising:
a collection step of collecting and hashing report information regarding various types of articles reported by clients and client information;
a storage step of storing the information, collected in the collection step, in a server, and storing the hashed report information and client information in a blockchain as hash values;
a conversion step of producing determination variables including a probability that report information uploaded by an actor is found to be actual report information and a utilization of negatively-confirmed report information of the actor through the information stored in the storage step;
a reliability calculation step of calculating a reliability score of a client through the determination variables produced in the conversion step;
a determination step of determining that the unconfirmed report information is negatively-confirmed report information by determining whether the unconfirmed report information is negative through an evaluation variable including at least one of the reliability score calculated in the reliability calculation step, a frequency of provision of unconfirmed report information within a short period of time, and a frequency of redundant provision of unconfirmed report information; and
an update step of updating the reliability score, calculated by the reliability calculation step, to a new reliability score depending on whether the report information is negative that is determined through the determination step.

12. The blockchain information determination method of claim 11, further comprising a reward step of providing a reward to a client who has made a report when the report information is determined to be negatively-confirmed report information in the determination step.
